(19) United States
(12) Patent Application Publication
(10) Pub. No.: US 2020/0325290 A1
(43) Pub. Date: Oct. 15, 2020

(54) Polymer Compositions Comprising Broad Molecular Weight Distribution Polypropylene and Articles Therefrom

(71) Applicant: ExxonMobil Chemical Patents Inc., Baytown, TX (US)

(72) Inventors: Sasha L. Schmitt, Houston, TX (US); Stefan B. Ohisson, Keerbergen (BE); Tyler M. Baran, Houston, TX (US); Edward Y. Bylina, Houston, TX (US); George J. Pehlert, Houston, TX (US)

(21) Appl. No.: 16/611,690

(22) PCT Filed: Apr. 6, 2018
(86) PCT No.: PCT/US2018/026446

§ 371 Date: Nov. 7, 2019

Related U.S. Application Data
(60) Provisional application No. 62/504,044, filed on May 10, 2017.

(30) Foreign Application Priority Data
Jun. 6, 2017 (EP) 17174467.5

(51) Int. Cl. C08J 5/18; C08L 23/06; B32B 27/08; B32B 27/32

(52) U.S. Cl. CPC C08J 5/18; C08L 23/06; B32B 27/08; B32B 27/32; C08L 2203/16; B32B 2250/03; C08L 2205/03; C08L 2207/066; C08J 2323/06; C08J 2423/06; C08J 2423/14; C08L 2205/025

(57) ABSTRACT

A composition suitable for a film having a 1% secant flexural modulus (MD or TD) of at least 55,000 psi and a dart drop impact of at least 500 g is provided. The composition comprises a broad molecular weight distribution polypropylene with at least 50 mol % propylene and having: a molecular weight distribution (Mw/Mn) greater than 6, a branching index (g′vis) of at least 0.95, and a melt strength of at least 2 cN; and a polyethylene with at least 70 mol % ethylene and having: a density of from 0.910 to 0.923 g/cm³, a melt index (I₂) of from 0.1 to 1.2 g/10 min, a melt index ratio (I₂₁/I₂) of from 20 to 35, a weight average molecular weight (M_{w}) of from 150,000 to 400,000 g/mol, and an orthogonal comonomer distribution and/or at least a first peak and at least a second peak in a comonomer distribution analysis.

### PRIORITY

This application claims priority to U.S. Provisional Application No. 62/504,044, filed May 10, 2017, and to EP 17174467.5 which was filed Jun. 6, 2017, the disclosures of which are both incorporated herein by reference.

### FIELD OF THE INVENTION

The present disclosure relates to blends of broad molecular weight distribution (BMWD) polypropylenes with certain polyethylenes, the blend forming a composition having a desirable balance of properties suitable for use in films, sheets and in particular, for thermoformed articles and foamed articles.

### BACKGROUND OF THE INVENTION

Polymer blends used in various durable products, such as thermoformed articles, blow molded articles and foamed articles, require a balance of many properties as well as good processability. In particular, such polymer blends require sufficient toughness and stiffness for increased durability and utility. However, achieving a balance of desirable properties along with good processability is challenging because improvement of one property often occurs at the expense of another property. For example, toughness (as measured by dart drop) may be enhanced but at the cost of maintaining sufficient stiffness (as measured by 1% secant flexural modulus) and vice versa.

Thus, there is a need for polymer compositions with a balance of both enhanced toughness and enhanced stiffness as well as good processability.

Related publications include: US 2015/065656; PCT/US2016/052115; WO 2017/027101; and PCT/US2017/016893.

### SUMMARY OF THE INVENTION

Disclosed herein is a polymer composition comprising a BMWD polypropylene and a polyethylene, wherein the BMWD polypropylene comprises at least 50 mol % propylene and has: a molecular weight distribution (Mw/Mn) greater than 6, a branching index (g′vis) of at least 0.95, and a melt strength of at least 2 cN determined using an extensional rheometer at 190° C., and the polyethylene comprises at least 70 mol % ethylene and has: a density of from 0.910 g/cm³ to 0.923 g/cm³, a melt index (I₂) of from 0.1 g/10 min to 1.2 g/10 min, a melt index ratio (I₂₁/I₂) of from 20 to 35, a weight average molecular weight (M_{w}) of from 150,000 g/mol to 400,000 g/mol, and an orthogonal comonomer distribution and optionally has at least a first peak and at least a second peak in a comonomer distribution analysis. Such polymer compositions are suitable for use in films. Additionally disclosed are articles, for example thermoformed, blow molded and foamed articles, comprising a polymer film as described herein.

### DETAILED DESCRIPTION OF THE INVENTION

It has been discovered that films and other articles having a balance of both enhanced toughness and stiffness may be achieved by providing a composition comprising certain polypropylene(s) having a broad molecular weight distribution with certain polyethylene(s) having an orthogonal comonomer distribution. As used here and throughout this specification and claims, the singular forms “a,” “an” and “the” include plural referents unless otherwise specified.

### I. Definitions & Measurement Techniques

Melt Flow Rates (MFR) tend to be used to describe polypropylenes, and Melt Index (12) and High Load Melt Index (121) tend to be used to describe polyethylenes. All are measured in accordance with ASTM D1238, where MFR is measured at 230° C. using 2.16 kg, I₂ is measured at 190° C. using 2.16 kg, and I₂₁ is measured at 190° C. using 21.6 kg.

Given that polymers are a collection of individual molecules each having its own molecular weight, the expression of the molecular weight of the collective “polymer” takes several statistical forms. The number average molecular weight (Mn) of the polymer is given by the equation Σ nᵢ Mᵢ/Σ nᵢ, where “M” is the molecular weight of each polymer “i”. The weight average molecular weight (Mw), z-average molecular weight (Mz), and Mz+1 value are given by the equation Σ nᵢ Mⁿ⁺¹/Σ nᵢMᵢⁿ, where for Mw, n=1, for Mz, n=2, and for Mz+1, n=3, where nᵢ in the foregoing equations is the number fraction of molecules of molecular weight Mᵢ. Reported values for Mn are ±2 kg/mole, for Mw are ±5 kg/mole, and for Mz are ±50 kg/mole. The expression “Mw/Mn” is the ratio of the weight average molecular weight (Mw) to the number average molecular weight (Mn), while the “Mz/Mw” is the ratio of the Mw to the Mz, an indication of the amount of high molecular weight component to the polypropylene.

Unless indicated otherwise, measurements of M_{w}, M_{z}, and Mₙ are determined by Gel Permeation Chromatography. The measurements proceed as follows. Gel Permeation Chromatography (Agilent PL-220), equipped with three in-line detectors, a differential refractive index detector (DRI), a light scattering (LS) detector, and a viscometer, is used. Experimental details, including detector calibration, are described in Effect of Short Chain Branching on the Coil Dimensions of Polyolefins in Dilute Solution in 34(19) MACROMOLECULES, 6812-6820 (2001). Three Agilent PLgel 10 μm Mixed-B LS columns are used. The nominal flow rate is 0.5 mL/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for 2 hours. All quantities are measured gravimetrically. The TCB densities used to express the polymer concentration in mass/volume units are 1.463 g/ml at 21° C. and 1.284 g/ml at 145° C. The injection concentration is from 0.5 to 2 mg/ml, with lower concentrations being used for higher molecular weight samples. Prior to running each sample, the DRI detector and the viscometer are purged. The flow rate in the apparatus is then increased to 0.5 ml/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and (dn/dc) is the refractive index increment for the system. The refractive index, n=1.500 for TCB at 145° C. and λ=690 nm. Units on parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature Dawn Heleos™. The molecular weight, M, at each point in the chromatogram is determined by analyzing the LS output using the Zimm model for static light scattering (W. Burchard & W. Ritchering, Dynamic Light Scattering from Polymer Solutions, in 80 PROGRESS IN COLLOID & POLYMER SCIENCE, 151-163 (Steinkopff, 1989):

$$\frac{{K}_{o} c}{Δ R ( θ )} = \frac{1}{M P ( θ )} + 2 {A}_{2} c$$

Here, ΔR(θ) is the measured excess Rayleigh scattering intensity at scattering angle θ, c is the polymer concentration determined from the DRI analysis, A₂ is the second virial coefficient. P(θ) is the form factor for a monodisperse random coil, and K_{O} is the optical constant for the system:

$${K}_{o} = \frac{4 {π}^{2} {{n}^{2} ( dn \text{/} d c )}^{2}}{{λ}^{4} {N}_{A}}$$

where N_{A} is Avogadro's number, and (dn/dc) is the refractive index increment for the system, which take the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c is concentration and was determined from the DRI output.

Alternatively, polymer molecular weight (Mₙ, M_{w}, M_{z}) are determined using Size-Exclusion Chromatography (SEC). Equipment consists of a High Temperature Size Exclusion Chromatograph (either from Waters Corporation or Polymer Laboratories), with a differential refractive index detector (DRI) or infrared (IR) detector. In the examples and specification herein, DRI was used, and mono-dispersed polystyrene is the standard with Mark-Houwink (MH) constants of α=0.6700, and K=0.000175. Three Polymer Laboratories PLgel 10 mm Mixed-B columns are used. The nominal flow rate is 0.5 cm³/min and the nominal injection volume is 300 μL. The various transfer lines, columns and differential refractometer (the DRI detector) are contained in an oven maintained at 135-145° C., and a dissolution temperature of 160° C. Solvent is prepared by dissolving 6 grams of butylated hydroxy toluene as an antioxidant in 4 liters of reagent grade 1,2,4-trichlorobenzene (TCB), the final concentration of polymer is from 0.4 to 0.7 mg/mL. The TCB mixture is then filtered through a 0.7 μm glass pre-filter and subsequently through a 0.1 μm Teflon filter. The TCB is then degassed with an online degasser before entering the column. The MH constants were as follows: K=0.000579, α=0.695 (DRI); and K=0.0002290, α=0.7050, (IR). Values for Mn are ±2,000 g/mole, for Mw are ±5,000 g/mole, and Mz are ±50,000 g/mole.

Unless indicated otherwise, the branching index (g′vis) is calculated using the output of the GPC-DRI-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits.

The branching index g′ᵥᵢₛ is defined as:

$${g}^{′} vis = \frac{{[ η ]}_{a v g}}{k {M}_{v}^{α}}$$

My is the viscosity-average molecular weight based on molecular weights determined by LS analysis. Z average branching index (g′zₐᵥₑ) is calculated using Ci=polymer concentration in the slice i in the polymer peak times the mass of the slice squared, Mi². All molecular weights are weight average unless otherwise noted. All molecular weights are reported in g/mol unless otherwise noted. This method is the preferred method of measurement and used in the examples and throughout the disclosures unless otherwise specified.

The broadness of the composition distribution of the polymer may be characterized by T₇₅−T₂₅ obtained via temperature rising elution fractionation (TREF). TREF is measured using an analytical size TREF instrument (Polymerchar, Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1° C./min. Subsequently, ODCB may be pumped through the column at a flow rate of 1 ml/min, and the column temperature may be increased at a constant heating rate of 2° C./min to elute the polymer. The polymer concentration in the eluted liquid may then be detected by means of measuring the absorption at a wavenumber of 2941 cm⁻¹ using an infrared detector. The concentration of the ethylene-α-olefin copolymer in the eluted liquid may be calculated from the absorption and plotted as a function of temperature. As used herein, T₇₅−T₂₅ values refer to where T₂₅ is the temperature (in degrees Celsius) at which 25% of the eluted polymer is obtained and T₇₅ is the temperature at which 75% of the eluted polymer is obtained via a TREF analysis. For example, in an embodiment, the polymer may have a T₇₅−T₂₅ value from 5 to 10, alternatively, a T₇₅−T₂₅ value from 5.5 to 10, and alternatively, a T₇₅−T₂₅ value from 5.5 to 8, alternatively, a T₇₅−T₂₅ value from 6 to 10, and alternatively, a T₇₅−T₂₅ value from 6 to 8, where T₂₅ is the temperature at which 25% of the eluted polymer is obtained and T₇₅ is the temperature at which 75% of the eluted polymer is obtained via TREF.

Unless indicated otherwise, the melt strength of the polymers described herein at a particular temperature may be determined using a Rheo-tester™ 1000 capillary rheotemer in combination with a Gottfert Rheotens Melt Strength Apparatus (Rheotens™ 71.97). To determine the melt strength, unless otherwise stated, a polymer melt strand extruded from the capillary die is gripped between two counter-rotating wheels on the apparatus. For the polypropylene, the take-up speed was increased at a constant acceleration of 12 mm/sec². The maximum pulling force (in the unit of cN) achieved before the strand breaks or starts to show draw-resonance is determined as the melt strength. The temperature of the rheometer was set at 190° C. The capillary die had a length of 30 mm and a diameter of 2 mm. The piston speed was set at 0.5 mm/s. The polymer melt was extruded from the die at a speed of 18 mm/sec. The distance between the die exit and the wheel contact point was 122 mm. The polyethylene was measured in a similar manner, but with an acceleration of 2.4 mm/sec².

Unless indicated otherwise, the dart drop of the polymers described herein was determined by dart impact phenolic ASTM D1709 Method A. The dart impact phenolic Method A measures the impact failure of plastic film (7″ across the web of the film) by a free falling dart at 26 in (Method A) height from a mechanical operated dart holder. The test specimens were conditioned for at least 40 hours after manufacturing at 23±2° C. and 50±10% relative humidity prior to testing. The procedure employs the “staircase method” testing technique which involves increasing/decreasing the dart weight depending on the pass/failure results of the dart impact. The increasing or decreasing increment of the dart weight depends on the initial fail, so a 5% less than (weight increment), or less than 15% increment was used when performing the staircase method. After getting the weight increment, the weight was decreased on the dart by the weight increment to get the pass point. The weight was increased only if the dart passes at the last dart drop, and the weight is decreased only if the dart fails at the last drop. The dart drop method is continued until a 10 pass and 10 fail ratio in the data was obtained. The F50 (Impact Failure) weight is the estimated weight at which 50% of the specimen would fail in the test. The calculations are shown below:
Failure—any break through the film that can be observed readily by feeling or viewing the specimen under a backlighting condition.
Black phenolic hemispherical head dimensions:
   1.5000.005″ (38.10±0.13 mm) diameter; and
   1.5010.25″ (6.4 mm) diameter shaft.
Impact failure (F50):

$$F 50 = \frac{{W}_{a} ( n i ) + {W}_{b} ( n i ) + {W}_{c} ( n i ) … etc .}{N}$$

Wₐ, W_{b}, W_{c},=weight of the dart;
ni=number of drops at that weight; and
N=total number of drops (20).

Unless indicated otherwise, the 1% secant flexural modulus (MD or TD) of the polymers herein was determined by conditioning and testing the specimens under ASTM laboratory conditions. The specimens are maintained at 23±2° C. and 50%+10% relative humidity for 40 hours. Each specimen was prepared with a precision cutter to cut the specimen to be 1 inch wide and 7 inches long. The 1% secant flexural modulus is based on ASTM D882, but samples were tested by the method using a jaw separation of 5 inches and a sample 1 inch wide. The index of stiffness of thin films is determined by pulling the specimen at a rate of jaw separation (crosshead speed) of 0.5 inches per minute to a designated strain of 1% of its original length and recording the load at these points. The calculation is provided below:

$$1 \% secant modulus ( psi ) = \frac{Load at 1 \%}{\begin{matrix}Average Thickness ( inches ) \times \\ Width ( inches\end{matrix}} \times 10 \; 0 .$$

Unless indicated otherwise, the tensile properties of the polymers herein were determined by conditioning and testing the specimens under ASTM laboratory conditions. The specimens are maintained at 23±2° C. and 50%+10% relative humidity for 40 hours. Each specimen was prepared with a precision cutter to cut the specimen to be 1 inch wide and 4 inches long. The tensile testing is based on ASTM D882, but samples were tested using a jaw separation of 2 inches and a sample 1 inch wide. The sample is pulled, at a constant set rate of 20 inches per minute, until the sample fails.

Yield Strength is the tensile stress at the point in the stress-strain curve in which the curve begins to bend and beyond which the material no longer behaves like a spring. Thus, the yield point is the first stress in a material, less than the maximum attainable stress, at which an increase in a strain occurs without an increase in stress. The Tensile at Yield was calculated using a 2% offset method.

Elongation at Yield is the increase in the gauge length of the test specimen at yield. (Yield defined above in the definition of the Tensile at Yield.) This is usually expressed in percentage of change of the original gauge length and refers to the elongation at the yield point.

Tensile Strength is the maximum tensile stress, which a material can sustain. It is calculated from the maximum load during a tension test, regardless of whether or not this load occurs at rupture, and the original cross-sectional area of the test specimen.

Elongation at Break is the elongation expressed as the percentage of change of the original gauge length (original length of the portion of the test specimen over which strain or change of length is determined) and refers to the elongation at the breaking point of the test specimen. The calculations are provided below:

$$Ultimate Tensile = \frac{Maximum Force}{Cross \text{-} Sectional Area} = psi$$

$$Yield Strength = \frac{Force at Yield}{Cross \text{-} Sectional Area} = psi$$

$$Elongation = \frac{Increase in Length}{Original Length} \times 100 \% = \% .$$

### II. Polymer Composition and Films

Provided herein is polymer composition comprising at least one broad molecular weight distribution (BMWD) polypropylene comprising at least 50 mol % propylene and having: a molecular weight distribution (M_{w}/Mₙ) greater than 6, a branching index (g′vis) of at least 0.95, and a melt strength of at least 2 cN determined using an extensional rheometer at 190° C.; and at least one polyethylene comprising at least 70 mol % ethylene and having: a density of from 0.910 g/cm³ to 0.923 g/cm³, a I₂ of from 0.1 g/10 min to 1.2 g/10 min, a melt index ratio (I₂₁/I₂) of from 20 to 35, a weight average molecular weight (M_{w}) of from 150,000 g/mol to 400,000 g/mol, and an orthogonal comonomer distribution and/or has at least a first peak and at least a second peak in a comonomer distribution analysis. The composition can be formed by blending the at least two components by any means such as melt extrusion in an extruder. The composition can be formed into pellets of polymer ready for shipment to another location or can be formed in an extruder used to actually form a film or other article. A particularly preferred use for the composition is in a film or at least one layer of a multi-layered film.

Polymers films having both enhanced toughness (as measured by dart drop) and stiffness (as measured by 1% secant flexural modulus) are provided herein. In particular, polymer films comprising at least one layer comprising a broad molecular weight distribution (BMWD) polypropylene and a polyethylene are provided herein, wherein the film has a 1% secant flexural modulus (MD or TD) of at least 55,000 psi and a dart drop impact of at least 500 g. It is contemplated herein, that the polymer films encompass polymer sheets. In various aspects, the polymer film may have an average thickness of less than 150 μm, or 25 μm to 150 μm, 50 μm to 125 μm, or 50 μm to 100 μm. Sheets as described herein have an average thickness of greater than or equal to 150 μm. Preferably, both films and/or sheets are flexible and can be folded, bent, and wrapped around shaped objects.

In various aspects, as further described herein, the polymer films can comprise additional polymer layers to form multi-layered films, sheets, or multi-layered sheets, which may be used to further form various articles, such as but not limited to thermoformed articles, blow molded articles and/or foamed articles.

Also, as used herein, “multi-layered” refers to structures including two or more polymers each forming a flat surface having an average thickness, the same or different, that have been combined together and caused to adhere to one another such as by application of radiation, heat, or use of adhesives to form a single multi-layer structure; preferably formed by a process of coextrusion utilizing two or more extruders to melt and deliver a steady volumetric throughput of different viscous polymers, one of which is the BMWD polypropylene, to a single extrusion head (die) which will extrude the materials in the desired form.

### A. Broad Molecular Weight Distribution Polypropylenes

The polymer films include at least a first layer comprising (or consisting of, or consisting essentially of) a polypropylene having a relatively high melt strength and a broad molecular weight distribution, referred herein simply as a “broad molecular weight distribution polypropylene” (or BMWD polypropylene). In particular, in any embodiment the BMWD polypropylene useful herein comprises at least 50, or 60, or 70, or 80, or 90 mol % propylene-derived monomer units, or within a range from 50, or 60, or 80 to 95, or 99 mol % propylene-derived units, the remainder of the monomer units selected from the group consisting of ethylene and C₄ to C₂₀ α-olefins, preferably ethylene or 1-butene. In any embodiment the BMWD polypropylene is a homopolymer of propylene-derived monomer units.

In any embodiment, the BMWD polypropylene may have an isopentad percentage of greater than 90, or 92, or 95%.

Also in any embodiment, the BMWD polypropylene may have a MFR from 0.1 or 1 or 2 g/10 min to 4, or 6 g/10 min.

In any embodiment, the BMWD polypropylene may have a weight average molecular weight (M_{w}) from 200,000, or 300,000, or 350,000 g/mol to 500,000, or 600,000, or 700,000 g/mol; a number average molecular weight (Mₙ) from 15,000, or 20,000 g/mol to 80,000, or 85,000, or 90,000 g/mole; and a z-average molecular weight (M_{z}) within a range from 900,000, or 1,000,000, or 1,200,000 g/mol to 1,800,000, or 2,000,000, or 2,200,000 g/mole, as measured by SEC described above. In any embodiment the BMWD polypropylene may have a molecular weight distribution (M_{w}/Mₙ) of greater than 6 or 7 or 8; or within a range from 6 or 7 or 8 or 10, or 12 to 14 or 16 or 18 or 20 or 24. Also, in any embodiment, the BMWD polypropylene may an M_{z}/M_{w} of greater than 3, or 3.4, or 3.6, or within a range from 3, or 3.4, or 3.6 to 3.8, or 4, or 4.4. Further, in any embodiment, the BMWD polypropylene may have a M_{z}/Mₙ of greater than 35, or 40, or 55, or 60, or within a range from 35, or 40, or 55 to 60, or 65, or 70, or 75, or 80.

The BWMD polypropylene useful herein tend to be highly linear as evidenced by a high branching index. Thus, in any embodiment the BWMD polypropylene may have a branching index (g′, also referred to in the literature as g′vis) of at least 0.95, 0.96, 0.98 or 0.98.

In any embodiment, the BMWD polypropylene useful herein may have a melt strength of at least 2, 5, 10, or 20 cN determined using an extensional rheometer at 190° C.; or within a range from 2, or 5, or 10 cN to 30, or 50, or 60, or 80 cN.

In any embodiment, the BWMD polypropylene may have a viscosity ratio from 20 to 80 determined from the complex viscosity ratio at 0.01 to 100 rad/s angular frequency at a fixed strain of 10% at 190° C. Also in any embodiment the BMWD polypropylene may have a peak extensional viscosity (annealed) within a range from 10, 15, or 20 kPa·s to 40 or 50 or 55 or 60 or 80 or 100 kPa·s at a strain rate of 0.01/sec (190° C.). The “peak extensional viscosity” is the difference between the highest value for the extensional viscosity and the linear viscoelastic response (LVE).

In any embodiment, the BMWD polypropylene may have a heat distortion temperature of greater than or equal to 100° C., determined according to ASTM D648 using a load of 0.45 MPa (66 psi). In any embodiment the BMWD polypropylene may have a 1% Secant flexural modulus from 1500 or 1600 MPa to 2400 or 2500 MPa determined according to ASTM D790A.

In any embodiment, the BMWD polypropylene may have a peak melting point temperature (second melt, Tm₂) of greater than 158, or 160, or 164° C., or within a range from 160, or 164° C. to 168, or 170° C.; and a crystallization temperature (Tc) of greater than 100, or 105, or 110° C., or within a range from 100, or 105, or 110° C. to 115, or 120° C. The crystallization and melting point temperatures are determined by Differential Scanning calorimetry (DCS) at 10° C./min on a Pyris™ 1 DSC. The DSC ramp rate is 10° C./min for both heating and cooling, and measured as follows: 1) hold for 10 min at −20° C.; 2) heat from −20° C. to 200° C. at 10° C./min; 3) hold for 10 min at 200° C.; 4) cool from 200° C. to −20° C. at 10° C./min; 5) hold for 10 min at −20° C.; and 6) heat from −20° C. to 200° C. at 10° C./min.

In any embodiment, the BMWD polypropylene may be a reactor-grade material (“reactor-grade polypropylene”), meaning that it is used as it comes out of the reactor from which it is produced, optionally having been further made into pellets of material that has not altered any of its properties such as the branching index, Mw/Mn, melt flow rate, etc., by more than 1% of its original value. This reactor-grade polypropylene may be used in the polymer films or sheets described herein.

In a preferred embodiment, the BMWD polypropylene reactively extruded with a peroxide or other visbreaking agent. Such treatment or “trimming” of the reactor grade BMWD polypropylene can preferably occur by chemical treatment with a long half-life organic peroxide. In any embodiment, the BMWD polypropylene's described herein are trimmed only by treatment with a long-half-life organic peroxide. Thus, in any embodiment the invention includes a process to prepare the BMWD polypropylene described herein comprising combining a high melt strength polypropylene comprising at least 50 mol % propylene, and having a molecular weight distribution (Mw/Mn) greater than 6, a branching index (g′ᵥᵢₛ) of at least 0.95, and a melt strength of at least 5, or 10 cN determined using an extensional rheometer at 190° C., with (i) within the range from 10, or 20 ppm to 100, or 500, or 1000 ppm of a long half-life organic peroxide.

By “long half-life organic peroxide,” what is meant is an organic peroxide (a peroxide-containing hydrocarbon) having a 1 hour half-life temperature (¹t_{1/2}) of greater than 100, or 110, or 120, or 130° C., as measured in C6 to C16 alkane such as dodecane or decane, or a halogenated aryl compound such as chlorobenzene.

Desirably, such peroxides include those having the general structure R¹—OO—R², or R¹—OO—R³—OO—R², or, more generally, (R¹—OO—R²)ₙ, where “n” is an integer from 1 to 5; and wherein each of R¹ and R² are independently selected from C2 to C10 alkyls, C6 to C12 aryls, and C7 to C16 alkylaryls, preferably iso- or tertiary-alkyls, and R³ is selected from C1 to C6, or C10 alkylenes, C6 to C12 aryls, and C7 to C16 alkylaryls; the “—OO—” being the peroxide moiety. Specific examples of desirable long half-life organic peroxides include 2,5-dimethyl-2,5-di(tert-butylperoxy)hexane, 2,5-Bis(tert-butylperoxy)-2,5-dimethylhexane, di-tertbutyl peroxide, and dicumyl peroxide.

The half-life is determined by differential scanning calorimetry-thermal activity monitoring of a dilute solution of the initiator in the desired solvent. The half-life can then be calculated from the Arrhenius plot as is well known in the art. Thus, by treating the HMS PP, having a large amount of a high molecular weight component or “tail”, with the long half-life peroxide the high molecular weight component is reduced or “trimmed”. The appropriate solvent is determined based on the solubility of the organic peroxide.

Otherwise, in any embodiment, the BMWD polypropylenes have not been cross-linked or reacted with any radiation or chemical substance such as a butadiene, 1,3-hexadiene, isoprene or other diene-containing compound, allyl compound, or bifunctionally unsaturated monomer(s) to cause cross-linking and/or long-chain branching, such as disclosed in, for example, U.S. Pat. No. 8,895,685. Typical forms of radiation known to cause cross-linking and/or long-chain branching include use of electron-beams or other radiation (beta- or gamma-rays) that interact with the polymer.

In various aspects, the BMWD polypropylene may be present in the composition or first layer in an amount of 30 wt % to 70 wt %, 30 wt % to 60 wt %, or 30 wt % to 50 wt %, based on the total weight of the composition or first layer.

### B. Polyethylenes

The polyethylenes for use in the polymer film may comprise from 70 mol % to 100 mol % of units derived from ethylene. The lower limit on the range of ethylene content may be 70 mol %, 75 mol %, 80 mol %, 85 mol %, 90 mol %, 92 mol %, 94 mol %, 95 mol %, 96 mol %, 97 mol %, 98 mol %, or 99 mol % based on the mol % of polymer units derived from ethylene. The polyethylene may have an upper ethylene limit of 80 mol %, 85 mol %, 90 mol %, 92 mol %, 94 mol %, 95 mol %, 96 mol %, 97 mol %, 98 mol %, 99 mol %, 99.5 mol %, or 100 mol %, based on polymer units derived from ethylene. For polyethylene copolymers, the polyethylene polymer may have less than 50 mol % of polymer units derived from a C₃ to C₂₀ olefin, preferably, an alpha-olefin, for example, hexene or octene. The lower limit on the range of C₃ to C₂₀ olefin-content may be 25 mol %, 20 mol %, 15 mol %, 10 mol %, 8 mol %, 6 mol %, 5 mol %, 4 mol %, 3 mol %, 2 mol %, 1 mol %, or 0.5 mol %, based on polymer units derived from the C₃ to C₂₀ olefin. The upper limit on the range of C₃ to C₂₀ olefin-content may be 20 mol %, 15 mol %, 10 mol %, 8 mol %, 6 mol %, 5 mol %, 4 mol %, 3 mol %, 2 mol %, or 1 mol %, based on polymer units derived from the C₃ to C₂₀ olefin. Any of the lower limits may be combined with any of the upper limits to form a range. Comonomer content is based on the total content of all monomers in the polymer.

In various embodiments, the polyethylenes may have minimal long chain branching (for example, less than 1 long-chain branch/1000 carbon atoms, preferably particularly 0.05 to 0.50 long-chain branch/1000 carbon atoms). Such values are characteristic of a linear structure that is consistent with a branching index, g′vis of at least 0.980, or 0.985, or 0.99, or 0.995, or a value of 1. While such values are indicative of little to no long chain branching, some long chain branches may be present (for example, less than 1 long-chain branch/1000 carbon atoms, preferably less than 0.5 long-chain branch/1000 carbon atoms, particularly 0.05 to 0.50 long-chain branch/1000 carbon atoms).

In some embodiments, the polyethylenes may have a density in accordance with ASTM D-4703 1183 from 0.910 to 0.925 g/cm³, from 0.910 to 0.923 g/cm³, from 0.910 to 0.920 g/cm³, from 0.915 to 0.921 g/cm³, from 0.910 to 0.918 g/cm³, from 0.912 to 0.918 g/cm³, or from 0.912 to 0.917 g/cm³.

The weight average molecular weight (M_{w}) of the polyethylenes may be from 15,000 to 500,000 g/mol, from 20,000 to 250,000 g/mol, from 25,000 to 150,000 g/mol, from 150,000 to 400,000 g/mol, from 200,000 to 400,000 g/mol, or from 250,000 to 350,000 g/mol.

In any embodiment the polyethylenes have a M_{w}/Mₙ from 1.5 to 5, from 2 to 4, from 3 to 4, or from 2.5 to 4.

The polyethylenes may have a z-average molecular weight (M_{z}) to weight average molecular weight (M_{w}) ratio greater than 1.5, or 1.7, or 2. In some embodiments, this ratio is from 1.7 to 3.5, from 2 to 3, or from 2.2 to 3.

The polyethylenes may have an 12 of 0.1 to 300 g/10 min, 0.1 to 100 g/10 min, 0.1 to 50 g/10 min, 0.1 g/10 min to 5 g/10 min, 0.1 g/10 min to 3 g/10 min, 0.1 g/10 min to 2 g/10 min, 0.1 g/10 min to 1.2 g/10 min, 0.2 g/10 min to 1.5 g/10 min, 0.2 g/10 min to 1.1 g/10 min, 0.3 g/10 min to 1 g/10 min, 0.4 g/10 min to 1 g/10 min, 0.5 g/10 min to 1 g/10 min, 0.6 g/10 min to 1 g/10 min, 0.7 g/10 min to 1 g/10 min, or 0.75 g/10 min to 0.95 g/10 min.

The polyethylenes may have a I₂₁/I₂ from 10 to 50, from 15 to 45, from 20 to 40, from 20 to 35, from 22 to 38, from 20 to 32, from 25 to 31, or from 28 to 30.

In various embodiments, the polyethylenes may have at least a first peak and a second peak in a comonomer distribution analysis, wherein the first peak has a maximum at a log(M_{w}) value of 4 to 5.4, 4.3 to 5, or 4.5 to 4.7; and a TREF elution temperature of 70° C. to 100° C., 80° C. to 95° C., or 85° C. to 90° C. The second peak in the comonomer distribution analysis has a maximum at a log(M_{w}) value of 5 to 6, 5.3 to 5.7, or 5.4 to 5.6; and a TREF elution temperature of 40° C. to 60° C., 45° C. to 60° C., or 48° C. to 54° C.

In any of the embodiments described above, the polyethylenes may have one or more of the following properties: an I₂ from 0.1 g/10 min to 5 g/10 min; a I₂₁/I₂ from 15 to 30; a M_{w} from 20,000 to 200,000 g/mol; a M_{w}/Mₙ from 2 to 4.5; and a density from 0.910 to 0.925 g/cm³. In any of these embodiments, the amount of hafnium is greater than the amount of zirconium and a ratio of hafnium to zirconium (ppm/ppm) may be at least 2, at least 10, at least 15, at least 17, at least 20, or at least 25.

In an alternative embodiment, the polyethylenes may have one or more of the following properties: an I₂ from 0.1 g/10 min to 1.2 g/10 min; an I₂₁/I₂ from 30 to 32; a M_{w} from 150,000 to 400,000 g/mol; a M_{w}/Mₙ from 2 to 4.5; and a density from 0.910 to 0.923 g/cm³.

In several of the classes of embodiments described above, the polyethylenes may have an orthogonal comonomer distribution. The term “orthogonal comonomer distribution” refers to an ethylene polymer wherein across the molecular weight range of the ethylene polymer molecules, the comonomer contents for the various polymer fractions are not substantially uniform and a higher molecular weight fraction thereof generally has a higher comonomer content than that of a lower molecular weight fraction. The term “substantially uniform comonomer distribution” is used herein to mean that comonomer content of the polymer fractions across the molecular weight range of the ethylene-based polymer vary by less than 10 wt %. In some embodiments, a substantially uniform comonomer distribution may refer to less than 8 wt %, or 5 wt %, or 2 wt %. Both a substantially uniform and an orthogonal comonomer distribution may be determined using fractionation techniques such as gel permeation chromatography-differential viscometry (GPC-DV), temperature rising elution fraction-differential viscometry (TREF-DV) or cross-fractionation techniques. See US2017-0363605 for a detailed description of orthogonal distribution polyethylenes suitable for the compositions, films and articles described herein.

The melt strength of the polyethylenes, as determined according to the method described above, may be in the range from 1 to 100 cN, 1 to 50 cN, 1 to 25 cN, 3 to 15 cN, 4 to 12 cN, or 5 to 10 cN.

Polyethylenes are commercially available from ExxonMobil Chemical Company, Houston, Tex., and sold under Exceed XP™ metallocene polyethylene (mPE). Exceed XP™ mPE offers step-out performance with respect to, for example, dart drop impact strength, flex-crack resistance, and machine direction (MD) tear, as well as maintaining stiffness at lower densities. Exceed XP™ mPE also offers optimized solutions for a good balance of melt strength, toughness, stiffness, and sealing capabilities which makes this family of polymers well-suited for blown film/sheet solutions.

In various aspects, the polyethylene may be present in the composition or first layer in an amount of 30 wt % to 70 wt %, 40 wt % to 70 wt %, or 50 wt % to 70 wt %, based on the total weight of the polymers or first layer.

In a particular embodiment, the BMWD polypropylene may be present in the composition or first layer in an amount of 30 wt % to 70 wt %, based on the total weight of the composition or first layer and the polyethylene may be present in the first layer in an amount of 30 wt % to 70 wt %, based on the total weight of the composition or first layer. In another embodiment, the BMWD polypropylene may be present in the first layer in an amount of 30 wt % to 50 wt %, based on the total weight of the composition or first layer and the polyethylene may be present in the first layer in an amount of 50 wt % to 70 wt %, based on the total weight of the composition or first layer.

### C. Additional Layers & Polymers

The polymer film or sheet described herein may be multi-layered as described above and further comprise additional polymer layers, such as at least a second layer, a third layer, a fourth layer, a fifth layer, etc. In particular, the polymer film may further comprise at least a second layer, and the polymer film may have a second layer/first layer structure. The first and second layer may be the same or different.

In another embodiment, the polymer film may further comprise at least a second layer and a third layer. The first, second and/or third layer may be the same or different. In such instances, the polymer film may have a structure corresponding to a second layer followed by a first layer followed by a third layer, which also is referred to herein as a second layer/first layer/third layer structure. Such a structure can be understood as the first layer present as “a core” with the second layer present as “a skin” in communication with a first surface of the first layer, and the third layer present as “another skin” in communication with a second surface of the first layer opposing the first surface.

In various aspects, the first layer may be present in an amount of 40 wt % to 70 wt %, or 50 wt % to 60 wt %. Additionally or alternatively, the second layer and the third layer each independently may be present in an amount of 15 wt % to 30 wt %, or 20 wt % to 25 wt %.

The additional polymer layers (for example, second layer, third layer) may each independently comprise one or more of: the BMWD polypropylene as described herein, the polyethylene as described herein and a different polyethylene.

In a particular embodiment, the first layer, the second layer and the third layer may be the same; further, each may comprise the BMWD polypropylene as described herein and the polyethylene as described herein. In such instances, the first layer may be present in an amount of 30 wt % to 40 wt %, and the second layer and the third layer each independently may be present in an amount of 30 wt % to 35 wt %.

i. First Additional Polyethylene

The different polyethylene may be a first additional polyethylene having 99 to 80 wt %, 99 to 85 wt %, 99 to 87.5 wt %, 99 to 90 wt %, 99 to 92.5 wt %, 99 to 95 wt %, or 99 to 97 wt %, of polymer units derived from ethylene and 1 to 20 wt %, 1 to 15 wt %, 1 to 12.5 wt %, 1 to 10 wt %, 1 to 7.5 wt %, 1 to 5 wt %, or 1 to 3 wt % of polymer units derived from one or more C₃ to C₂₀ α-olefin comonomers, preferably C₃ to C₁₀ α-olefins, and more preferably C₄ to C₈ α-olefins. The α-olefin comonomer may be linear, branched, cyclic and/or substituted, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene, and mixtures thereof.

In various aspects, the first additional polyethylene comprises from 8 wt % to 15 wt %, of C₃ to C₁₀ α-olefin derived units, and from 92 wt % to 85 wt % ethylene derived units, based upon the total weight of the polymer.

In another embodiment, the first additional polyethylene comprises from 9 wt % to 12 wt %, of C₃ to C₁₀ α-olefin derived units, and from 91 wt % to 88 wt % ethylene derived units, based upon the total weight of the polymer.

The first additional polyethylenes may have a 12 of at least 0.10 g/10 min, or 0.15 g/10 min, or 0.18 g/10 min, or 0.20 g/10 min, or 0.22 g/10 min, or 0.25 g/10 min, or 0.28, or 0.30 g/10 min. Additionally, the first additional polyethylenes may have an 12 less than or equal to 3 g/10 min, or 2 g/10 min, or 1.5 g/10 min, or 1 g/10 min, or 0.75 g/10 min, or 0.50 g/10 min, or 0.40 g/10 min, or 0.30 g/10 min, or 0.25 g/10 min, or 0.22 g/10 min, or 0.20 g/10 min, or 0.18 g/10 min, or 0.15 g/10 min. Ranges expressly disclosed include, but are not limited to, ranges formed by combinations any of the above-enumerated values, for example, from 0.1 to 3, 0.2 to 2, 0.2 to 0.5 g/10 min, etc.

The first additional polyethylenes may have a I₂₁/I₂ from 25 to 80, alternatively, from 25 to 60, alternatively, from 30 to 55, and alternatively, from 35 to 50.

The first additional polyethylenes may have a density of at least 0.905 g/cm³, or 0.910 g/cm³, or 0.912 g/cm³, or 0.913 g/cm³, or 0.915 g/cm³, or 0.916 g/cm³, or 0.917 g/cm³, or 0.918 g/cm³. Additionally or alternatively, first additional polyethylenes may have a density less than or equal to 0.945 g/cm³, or 0.940 g/cm³, or 0.937 g/cm³, or 0.935 g/cm³, or 0.930 g/cm³, or 0.925 g/cm³, or 0.920 g/cm³, or 0.918 g/cm³. Ranges expressly disclosed include, but are not limited to, ranges formed by combinations any of the above-enumerated values, for example, from 0.905 to 0.945 g/cm³, 0.910 to 0.935 g/cm³, 0.912 to 0.930 g/cm³, 0.916 to 0.925 g/cm³, 0.918 to 0.920 g/cm³, etc. Density is determined using chips cut from plaques compression molded in accordance with ASTM D-1928 Procedure C, aged in accordance with ASTM D-618 Procedure A, and measured as specified by ASTM D-1505.

Typically, although not necessarily, the first additional polyethylenes may have a molecular weight distribution (MWD, defined as M_{w}/Mₙ) of 2.5 to 5.5, preferably 3 to 4.

The melt strength may be in the range from 1 to 100 cN, 1 to 50 cN, 1 to 25 cN, 3 to 15 cN, 4 to 12 cN, or 5 to 10 cN.

The first additional polyethylenes (or films or sheets made therefrom) may also be characterized by an averaged 1% secant flexural modulus (M) of from 10,000 to 60,000 psi (pounds per square inch), alternatively, from 20,000 to 40,000 psi, alternatively, from 20,000 to 35,000 psi, alternatively, from 25,000 to 35,000 psi, and alternatively, from 28,000 to 33,000 psi, and a relation between M and the dart drop impact strength in g/mil (DIS) complying with formula (A):

DIS≥0.8*[100+e^{(11.71-0.000268M+2.183×10}^{^{−9}}^{M}^{²}⁾], (A)

where “e” represents 2.7183, the base Napierian logarithm, M is the averaged modulus in psi, and DIS is the 26 inch dart impact strength. The DIS is preferably from 120 to 1000 g/mil, even more preferably, from 150 to 800 g/mil.

Typically, the first additional polyethylenes may have a g′vis of 0.85 to 0.99, particularly, 0.87 to 0.97, 0.89 to 0.97, 0.91 to 0.97, 0.93 to 0.95, or 0.97 to 0.99.

The first additional polyethylenes may be made by any suitable polymerization method including solution polymerization, slurry polymerization, supercritical, and gas phase polymerization using supported or unsupported catalyst systems, such as a system incorporating a metallocene catalyst.

Suitable commercial polymers for the first additional polyethylenes are available from ExxonMobil Chemical Company as Enable™ metallocene polyethylene (mPE) resins.

ii. Second Additional Polyethylene

Additionally or alternatively, the different polyethylene may be a second additional polyethylene comprising at least 50 wt % of polymer units derived from ethylene and less than 50 wt %, preferably 1 wt % to 35 wt %, even more preferably 1 to 6 wt % of polymer units derived from a C₃ to C₂₀ alpha-olefin comonomer (for example, hexene or octene).

The second additional polyethylene may have a density of at least 0.910 g/cm³, or 0.915 g/cm³, or 0.920 g/cm³, or 0.925 g/cm³, or 0.930 g/cm³, or 0.940 g/cm³. Alternatively, the second polyethylene polymer may have a density of less than or equal to 0.950 g/cm³, or 0.940 g/cm³, or 0.930 g/cm³, or 0.925 g/cm³, or 0.920 g/cm³, or 0.915 g/cm³. Ranges expressly disclosed include ranges formed by combinations any of the above-enumerated values, for example, 0.910 to 0.950 g/cm³, 0.910 to 0.930 g/cm³, 0.910 to 0.925 g/cm³, etc. Density is determined using chips cut from plaques compression molded in accordance with ASTM D-1928 Procedure C, aged in accordance with ASTM D-618 Procedure A, and measured as specified by ASTM D-1505.

The second additional polyethylene may have a 12 of at least 0.5 g/10 min, or, or 0.7 g/10 min, or 0.9 g/10 min, or 1.1 g/10 min, or 1.3 g/10 min, or 1.5 g/10 min, or 1.8 g/10 min. Alternatively, the 12 may be less than or equal to 8 g/10 min, or 7.5 g/10 min, or 5 g/10 min, or 4.5 g/10 min, or 3.5 g/10 min, or 3 g/10 min, or 2 g/10 min, for example, or 1.8 g/10 min, or 1.5 g/10 min, or 1.3 g/10 min, or 1.1 g/10 min, or 0.9 g/10 min, or 0.7 g/10 min, 0.5 to 2 g/10 min, particularly 0.75 to 1.5 g/10 min. Ranges expressly disclosed include ranges formed by combinations any of the above-enumerated values, for example, 0.5 to 8 g/10 min, 0.7 to 1.8 g/10 min, 0.9 to 1.5 g/10 min, 0.9 to 1.3, 0.9 to 1.1 g/10 min, 1 g/10 min, etc.

The second polyethylenes are generally considered linear. Suitable second additional polyethylene polymers are available from ExxonMobil Chemical Company under the trade name Exceed™ metallocene (mPE) resins. The I₂₁/I₂ for Exceed materials will typically be from 15 to 20.

### D. Optional Additives

The polymer compositions, and articles containing the compositions described above may be used in combination with other polymers, additives, processing aids, etc. For example, each layer may comprise a “neat” polymer with optional processing aids and/or additives or may comprise a blend of polymers with optional processing aids and/or additives.

In any embodiment, an additive may be present up to 1, or 2, or 3 wt % by weight of polymer films described herein. An additive may be added before, during, or after the formation of the polymer films or sheets. Additives include a first antioxidant (e.g., octadecyl-3-(3,5-di-tert.butyl-4-hydroxyphenyl)-propionate and other proprionates), a second antioxidant such as C₂-C₇, preferably C₂-C₄, and alkyl aryl phosphites mixed structures, neutralizing agents such as hydrotalcite, and other compounds including, but not limited to, fillers (especially, silica, glass fibers, talc, etc.) colorants or dyes, pigments, color enhancers, whitening agents, UV stabilizers, cavitation agents, anti-slip agents, lubricants, plasticizers, processing aids, tackifiers, antistatic agents, antifogging agents, nucleating agents (both α-nucleators and β-nucleators), stabilizers such as lactone and vitamin E, mold release agents, other antioxidants (for example, hindered amines and phosphates), anti-blocking agents, anti-blooming agents, and other common additives as is known in the art. Nucleating agents include, for example, sodium benzoate, talc, and Hyperform™ HPN 68-L (Milliken). Slip agents include, for example, oleamide and erucamide. Individually, an additive is preferably present in an amount from 10, or 50 ppm to 500, or 1000, or 2000, or 4000 ppm.

### III. End Use Applications

Various articles are provided herein, which comprise a polymer film or sheet as described above. In any embodiment, a thermoformed article comprising a polymer film or sheet described herein are provided. Thermoforming is a fabrication process which involves heating a sheet(s) of material such as a polyolefin and forming it over a male or female mold. The two basic types of thermoforming processes—vacuum forming and pressure forming, and derivative processes such as twin sheet thermoforming—make plastic thermoforming a broad and diverse plastic forming process. Thermoformed plastics are suited for automotive, consumer products, packaging, retail and display, sports and leisure, electronics, and industrial applications. The most advantageous aspects of thermoforming are its low tooling and engineering costs and fast turnaround time which makes thermoforming or vacuuforming ideal for prototype development and low-volume production. Non-limiting examples of thermoformed articles comprising multi-layered sheets described herein include pallets, tubs, dunnage, food containers (especially frozen food containers), and other durable goods.

The mono- or multi-layered films or sheets described herein have many advantages, such as enhanced toughness (as measured by dart drop) and stiffness (as measured by 1% secant flexural modulus) and vice versa. Thus, the polymer films or sheets described herein may have a 1% secant flexural modulus (MD or TD), measured according to above-described method, of at least 50,000 psi (344 MPa), or 55,000 psi (379 MPa), or 60,000 psi (413 MPa), or 65,000 psi (448 MPa), or 70,000 psi (482 MPa), or 75,000 psi (517 MPa), or 80,000 psi (551 MPa), or 90,000 psi (620 MPa), or 95,000 psi (655 MPa), or 100,000 psi (689 MPa), or within a range from 50,000 psi (344 MPa) to 100,000 psi (689 MPa), 55,000 psi (379 MPa) to 100,000 psi (689 MPa), or 60,000 psi (413 MPa) to 100,000 psi (689 MPa), or 65,000 psi (448 MPa) to 100,000 psi (689 MPa), or 55,000 psi (379 MPa) to 95,000 psi (655 MPa), or 65,000 psi (448 MPa) to 95,000 psi (655 MPa), or 70,000 psi (482 MPa) to 95,000 psi (655 MPa).

Further, the polymer films or sheets described herein may have a desirable dart drop reported in grams (g) or (g/mil) and measured in accordance with the above-described method. The dart head is phenolic. It calculates the impact failure weight, i.e., the weight for which 50% of the test specimens will fail under the impact. Thus, in various aspects, the polymer films or sheets described herein may have a dart drop of at least 500 g, or 600 g, or 700 g, or 800 g, or 900 g, or 1000 g, or 1100 g, or 1200 g, or 1300 g, or 1400 g, or 1500 g, or a dart drop of 500 g to 1500 g, or 500 g to 1400 g, or 600 g to 1400 g. In a particular embodiment, the polymer films or sheets described herein may have a 1% secant flexural modulus (MD or TD) of at least 55,000 psi (379 MPa) or 65,000 psi (448 MPa) or 70,000 psi (482 MPa) and/or a dart drop impact of 500 g or 600 g.

The polymer films or sheets described herein also have other desirable properties. In any embodiment, the films may have an Elmendorf Tear (MD or TD), measured according to ASTM 1922, within a range from 300 g to 1600 g, or 400 g to 1600 g, or 500 g to 1600 g. Also in any embodiment, the polymer films or sheets described herein may have a haze, as measured according to ASTM D1003 of less than or equal to 30%, or 25%, or 20%, or 15%, or 10%, or the polymer films or sheets described herein may have a haze of 10% to 30%, or 10% to 25%, or 10% to 20%.

In any embodiment, a blow molded article is provided herein, which comprises a polymer film or sheet described herein. Blow molding is a molding process in which air pressure is used to inflate soft plastic into a mold cavity. It is a useful process for making one-piece hollow plastic parts with thin walls, such as bottles and similar containers. Since many of these items are used for consumer beverages for mass markets, production is typically organized for very high quantities. The blow molding process begins with melting down the polymer composition and forming it into a parison or in the case of injection and injection stretch blow molding (ISB) a preform. An air tube is inserted in the parison through which compressed air can pass. The parison is then clamped into a mold and air is blown into it. The air pressure then pushes the molten or soft polymer composition out to match the mold. Once the polymer composition has cooled and hardened the mold opens up and the part is ejected.

Extrusion blow molding typically consists of a cycle of 4 to 6 steps. In most cases, the process is organized as a very high production operation for making plastic bottles. The sequence is automated and usually integrated with downstream operations such as bottle filling and labeling. It is preferred that the blown container be rigid, and rigidity depends on wall thickness and the nature of the materials being used. The steps in extrusion blow molding can include: (1) extrusion of the polymer composition to form the parison; (2) parison is pinched at the top and sealed at the bottom around a metal blow pin as the two halves of the mold come together; (3) the tube is inflated so that it takes the shape of the mold cavity; and (4) mold is opened to remove the solidified part.

In injection blow molding, the starting parison is injection molded rather than extruded. A simplified sequence is outlined below. Compared to its extrusion-based competitor, the injection blow-molding process has a lower production rate. The steps of injection blow molding can include: (1) parison is injection molded around a blowing rod; (2) injection mold is opened and parison is transferred to a blow mold; (3) soft polymer is inflated to conform to a blow mold; and (4) blow mold is opened and blown product is removed. Non-limiting examples of blow molded articles comprising multi-layered sheets described herein include drums, bottles, hollow panels, sheds and utility structures.

In any embodiment, a profile is provided herein, which comprises a polymer film or sheet described herein. Profile extrusion is extrusion of a shaped product that can be a variety of configurations, and can include solid forms as well as hollow forms. Products ranging from tubing to window frames to vehicle door seals are manufactured this way and considered profile extrusion. To process hollow profiled shapes, a pin or mandrel is utilized inside the die to form the hollow section or sections. Multiple hollow sections require multiple pins. To create these hollow sections a source of positive air pressure is required to allow the center of the product to maintain shape and not collapse in a vacuum. When two or more materials are required to make a product, the co-extrusion process is preferably used. For example, a white drinking straw that has two colors of stripes, requires a total of three extruders. Each extruder feeds a different material or variation of the same material into a central co-extrusion die. Non-limiting examples of articles made from (comprising, or consisting of) a profile comprising at least one layer of a BMWD polypropylene described herein includes pipes, structural frames, siding, tubing, decking, window and door frames (fenestration).

In any embodiment, a foamed article is provided herein, which comprises a polymer film or sheet described herein. For example, the polymers described herein may further comprise a foaming agent as is known in the art to effect the formation of air containing pockets or cells within the composition, thus creating an “expanded” or “foamed” films, sheet and/or profile, and article made therefrom. In any embodiment the sheets and/or articles described herein are the reaction product of a foaming agent within the polymer making up the films, sheets, profiles and/or articles made therefrom. This reaction product may be formed into any number of suitable foamed articles such as cups, plates, other food containing items, and food storage boxes, toys, handle grips, automotive components, and other articles of manufacture as described herein. Advantageously, such foamed articles comprising the polymer film or sheet as described herein can have a reduced tendency for flow induced crystallization.

In any embodiment, a blown film extrusion article is provided herein, which comprises a polymer film or sheet described herein. The blown film extrusion can be a monolayer and/or a multi-layered structure. Non-limiting examples of blown film extrusion articles comprising polymer films or sheets described herein include heavy duty sacks and portions of laminated stand up pouches. It also contemplated herein, that the polymer films or sheets described herein may be utilized in other high temperature applications.

The various descriptive elements and numerical ranges disclosed herein for the inventive multi-layered structures and methods of forming such can be combined with other descriptive elements and numerical ranges to describe the invention(s); further, for a given element, any upper numerical limit can be combined with any lower numerical limit described herein, including the examples in jurisdictions that allow such combinations. The features of the inventions are demonstrated in the following non-limiting examples.

### EXAMPLES

### Example 1—Preparation of Polymer Films

Various polymer films were prepared having a structure comprising a core layer with a first skin layer and a second skin layer disposed on opposing surfaces of the core layer in a first skin layer/core layer/second skin layer structure (also described herein as a second layer/first or core layer/third layer structure).

The polymers used to prepare the films are provided below in Table 1. The “BMW-PP” is a polypropylene homopolymer produced in a slurry polymerization reactor by contacting propylene with an Avant™ ZN168 catalyst (Equistar Chemical Company, Houston Tex.), and propyltriethoxysilane and dicyclopentyldimethoxysilane as external donors, and hydrogen to a final MFR as stated in Table 1, this base polypropylene was then reactively extruded with 40 ppm of Trigonox™ 101 peroxide. All of the below polymers were obtained from ExxonMobil Chemical Company.

TABLE 1
Polymer Properties

| | | Density | Melt | |
|---|---|---|---|---|
| Polymer | Type | (g/cm³) | Index (I₂) | MFR |
| Enable ™ 20-05HH (PE1) | low density metallocene | 0.920 | 0.50 | — |
| | polyethylene | | | |
| Exceed ™ 1023JA (PE2) | low density metallocene | 0.923 | 1.0 | — |
| | polyethylene | | | |
| Exceed ™ 1018HA (PE3) | low density metallocene | 0.918 | 1.0 | — |
| | polyetheylene | | | |
| Exceed ™ 1012HA (PE4) | low density metallocene | 0.912 | 1.0 | — |
| | polyetheylene | | | |
| Exceed ™ 1012CA (PE5) | low density metallocene | 0.912 | 1.0 | — |
| | polyetheylene | | | |
| Exceed ™ XP 8656 ML (PE6) | low density polyetheylene | 0.916 | 0.50 | — |
| LD 051.LQ (LDPE) | low density polyethylene | 0.919 | 0.25 | — |
| HD 7845.30 (HDPE) | high density polyethylene | 0.958 | 0.45 | 0.81 |
| BMW-PP | polypropylene, treated with 40 | 0.90 | 1.63 | 3.45 |
| | ppm of Trigonox ™ 101 | | | |

The composition of the films prepared using the polymers from Table 1 are shown below in Tables 2 and 3.

TABLE 2
Composition of Comparative Films

| | | | | Layer Amounts |
|---|---|---|---|---|
| | 1^{st} Skin | | 2^{nd} Skin | (wt %) (1st skin/ |
| | Composition | Core Composition | Composition | core/2nd skin) |
| Comparative | 20 wt % LDPE + | 40 wt % BMW-PP + | 20 wt % LDPE + | 25/50/25 |
| Film A | 80 wt % PE2 | 60 wt % PE3 | 80 wt % PE2 | |
| Comparative | 20 wt % LDPE + | 40 wt % HD7845 + | 20 wt % LDPE + | 25/50/25 |
| Film B | 80 wt % PE2 | 60 wt % PE6 | 80 wt % PE2 | |
| Comparative | 20 wt % LDPE + | 80 wt % HD7845 + | 20 wt % LDPE + | 25/50/25 |
| Film C | 80 wt % PE2 | 20 wt % PE6 | 80 wt % PE2 | |
| Comparative | 20 wt % LDPE + | 40 wt % BMW-PP + | 20 wt % LDPE + | 25/50/25 |
| Film D | 80 wt % PE2 | 60 wt % PE4 | 80 wt % PE2 | |
| Comparative | 20 wt % LDPE + | 50 wt % BMW-PP + | 20 wt % LDPE + | 25/50/25 |
| Film E | 80 wt % PE2 | 50 wt % PE4 | 80 wt % PE2 | |

TABLE 3
Composition of Films 1-8

| | | | | Layer Amounts |
|---|---|---|---|---|
| | 1^{st} Skin | | 2^{nd} Skin | (wt %) (1st skin/ |
| | Composition | Core Composition | Composition | core/2nd skin) |
| Film 1 | 20 wt % LDPE + | 40 wt % BMW-PP + | 20 wt % LDPE + | 25/50/25 |
| | 80 wt % PE2 | 60 wt % PE6 | 80 wt % PE2 | |
| Film 2 | 40 wt % PE5 + | 40 wt % BMW-PP + | 40 wt % PE5 + | 25/50/25 |
| | 40 wt % PE2 + | 60 wt % PE6 | 40 wt % PE2 + | |
| | 20 wt % LDPE | | 20 wt % LDPE | |
| Film 3 | 40 wt % PE5 + | 40 wt % BMW-PP + | 40 wt % PE5 + | 25/50/25 |
| | 40 wt % PE2 + | 60 wt % PE6 | 40 wt % PE2 + | |
| | 20 wt % PE1 | | 20 wt % PE1 | |
| Film 4 | 40 wt % BMW-PP + | 40 wt % BMW-PP + | 40 wt % BMW-PP + | 25/50/25 |
| | 60 wt % PE6 | 60 wt % PE6 | 60 wt % PE6 | |
| Film 5 | 20 wt % LDPE + | 40 wt % BMW-PP + | 20 wt % LDPE + | 25/50/25 |
| | 80 wt % PE2 | 60 wt % PE6 | 80 wt % PE2 | |
| Film 6 | 20 wt % PE1 + | 40 wt % BMW-PP + | 20 wt % PE1 + | 25/50/25 |
| | 80 wt % PE6 | 60 wt % PE6 | 80 wt % PE6 | |
| Film 7 | 20 wt % PE1 + | 40 wt % BMW-PP + | 20 wt % PE1 + | 20/60/20 |
| | 80 wt % PE6 | 60 wt % PE6 | 80 wt % PE6 | |
| Film 8 | 80 wt % PE6 + | 30 wt % BMW-PP + | 80 wt % PE6 + | 25/50/25 |
| | 20 wt % PE1 | 70 wt % PE6 | 20 wt % PE1 | |

The first skin layer for each film was prepared using a 65 mm grooved extruder (“Extruder A”). The core layer for each film was prepared with a 90 mm grooved extruder (“Extruder B”). The second skin layer for each film was prepared with a 65 mm smooth extruder (“Extruder C”). For Extruders A, B, and C, the die diameter was 250 mm, the die gap was 60 mm, the gauge was 3.5 mm, the BUR was 2.5, the lay flat was 38.65 inch, the feed throat temperature was 100° C., and the default screw design was used. The IBC temperature was 65° C., the air ring temperature was 65° C., and the nip roll temperature was 110° C. Specific details the extruder conditions for the preparation of each film are shown below in Tables 4 and 5.

TABLE 4
Extruder Conditions for Preparation of Comparative Films A-E
COMPARATIVE FILM A

| Total Extrusion Rate | 309.2 lb/hr | | |
|---|---|---|---|
| Die Factor | 10 lb/hr/in-circumference | | |
| Target Line Speed | 47.96 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 224 | 224 | 224 |

COMPARATIVE FILM B

| Total Extrusion Rate | 309.2 lb/hr | | |
|---|---|---|---|
| Die Factor | 10 lb/hr/in-circumference | | |
| Target Line Speed | 47.39 ft/min | | |
| Layer | 1^{st} Skin | Core | 2^{nd} Skin |
| Extruder | A | B | C |
| Barrel #1 Temp. (° C.) | 200 | 200 | 200 |
| Barrel #2 Temp. | 230 | 230 | 230 |
| Barrel #3-5 Temp. | 210 | 210 | 210 |
| Zone #6 Temp. | 210 | 210 | 210 |
| Zone #7 Temp. | 210 | 210 | 210 |
| Die Zone #1-4 Temp. | 213 | 213 | 213 |

COMPARATIVE FILM C

| Total Extrusion Rate | 309.2 lb/hr | | |
|---|---|---|---|
| Die Factor | 10 lb/hr/in-circumference | | |
| Target Line Speed | 46.97 ft/min | | |
| Layer | 1^{st} Skin | Core | 2^{nd} Skin |
| Extruder | A | B | C |
| Barrel #1 Temp. (° C.) | 200 | 200 | 200 |
| Barrel #2 Temp. | 230 | 230 | 230 |
| Barrel #3-5 Temp. | 210 | 210 | 210 |
| Zone #6 Temp. | 210 | 210 | 210 |
| Zone #7 Temp. | 210 | 210 | 210 |
| Die Zone #1-4 Temp. | 213 | 213 | 213 |

COMPARATIVE FILM D

| Total Extrusion Rate | 463.8 lb/hr | | |
|---|---|---|---|
| Die Factor | 15 lb/hr/in-circumference | | |
| Target Line Speed | 72.08 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 227 | 227 | 227 |

COMPARATIVE FILM E

| Total Extrusion Rate | 463.8 lb/hr | | |
|---|---|---|---|
| Die Factor | 15 lb/hr/in-circumference | | |
| Target Line Speed | 72.13 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 227 | 227 | 227 |

TABLE 5
Extruder Conditions for Preparation of Films 1-8
FILM 1

| Total Extrusion Rate | 309.2 lb/hr | | |
|---|---|---|---|
| Die Factor | 10 lb/hr/in-circumference | | |
| Target Line Speed | 47.99 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 224 | 224 | 224 |

FILM 2

| Total Extrusion Rate | 309.2 lb/hr | | |
|---|---|---|---|
| Die Factor | 10 lb/hr/in-circumference | | |
| Target Line Speed | 48.11 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 224 | 224 | 224 |

FILM 3

| Total Extrusion Rate | 309.2 lb/hr | | |
|---|---|---|---|
| Die Factor | 10 lb/hr/in-circumference | | |
| Target Line Speed | 48.1 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 224 | 224 | 224 |

FILM 4

| Total Extrusion Rate | 309.2 lb/hr | | |
|---|---|---|---|
| Die Factor | 15 lb/hr/in-circumference | | |
| Target Line Speed | 46 ft/min | | |
| Layer | 1^{st} Skin | Core | 2^{nd} Skin |
| Extruder | A | B | C |
| Barrel #1 Temp. (° C.) | 210 | 210 | 210 |
| Barrel #2 Temp. | 240 | 240 | 240 |
| Barrel #3-5 Temp. | 221 | 221 | 221 |
| Zone #6 Temp. | 221 | 221 | 221 |
| Zone #7 Temp. | 221 | 221 | 221 |
| Die Zone #1-4 Temp. | 224 | 224 | 224 |

FILM 5

| Total Extrusion Rate | 463.8 lb/hr | | |
|---|---|---|---|
| Die Factor | 15 lb/hr/in-circumference | | |
| Target Line Speed | 71.99 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 227 | 227 | 227 |

FILM 6

| Total Extrusion Rate | 463.8 lb/hr | | |
|---|---|---|---|
| Die Factor | 15 lb/hr/in-circumference | | |
| Target Line Speed | 72.2 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 227 | 227 | 227 |

FILM 7

| Total Extrusion Rate | 463.8 lb/hr | | |
|---|---|---|---|
| Die Factor | 15 lb/hr/in-circumference | | |
| Target Line Speed | 72.26 ft/min | | |
| Layer | 1^{st} Skin | Core | 2^{nd} Skin |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 227 | 227 | 227 |

FILM 8

| Total Extrusion Rate | 463.8 lb/hr | | |
|---|---|---|---|
| Die Factor | 15 lb/hr/in-circumference | | |
| Target Line Speed | 72.14 ft/min | | |
| Layer | 1^{st} Skin | Core | 2^{nd} Skin |
| Extruder | A | B | C |
| Barrel #1 Temp. (° C.) | 200 | 210 | 200 |
| Barrel #2 Temp. | 230 | 240 | 230 |
| Barrel #3-5 Temp. | 210 | 221 | 210 |
| Zone #6 Temp. | 210 | 221 | 210 |
| Zone #7 Temp. | 210 | 221 | 210 |
| Die Zone #1-4 Temp. | 227 | 227 | 227 |

### Example 2—Film Properties

One or more of the following properties were tested for each film:
Thickness (average, low, high) as measured according to ASTM D6988;
1% secant flexural modulus as measured according to the above-described method;
Tensile properties (i.e. yield strength, elongation at yield, tensile strength, and elongation at break) as measured according to the above-described method;
Elmendorf Tear as measured according to ASTM D1922-15;
Dart Drop as measured according to the above-described method; and
Haze as measured according to ASTM D1003.
   The properties for Comparative Films A-E and Films 1-8 are shown below in Tables 6 and 7, respectively.

TABLE 6
Properties of Comparative Films A-E

| | COMPARATIVE FILMS | | | | |
|---|---|---|---|---|---|
| Property | A | B | C | D | E |
| Thickness (mils) | | | | | |
| Average | 3.57 | 3.60 | 3.61 | 3.48 | 3.56 |
| Low | 3.35 | 3.40 | 3.45 | 3.12 | 3.06 |
| High | 3.73 | 3.83 | 3.82 | 3.80 | 3.86 |
| 1% Secant (psi) | | | | | |
| MD | 70,487 | 46,418 | 68,931 | 68,760 | 80,593 |
| TD | 67,354 | 54,345 | 77,024 | 65,884 | 77,641 |
| Tensile | | | | | |
| Yield Strength (psi) | | | | | |
| MD | 2,401 | 1,840 | 2,411 | 2,254 | 2,464 |
| TD | 2,486 | 2,242 | 2,851 | 2,204 | 2,570 |
| Elongation at Yield (%) | | | | | |
| MD | 6.3 | 5.9 | 6.0 | 5.5 | 5.5 |
| TD | 6.4 | 6.5 | 6.9 | 5.6 | 5.9 |
| Tensile Strength (psi) | | | | | |
| MD | 6,319 | 5,942 | 5,553 | 6,388 | 6,833 |
| TD | 6,849 | 6,266 | 5,614 | 6,599 | 6,639 |
| Elongation at Break (%) | | | | | |
| MD | 668 | 645 | 694 | 673 | 681 |
| TD | 709 | 673 | 719 | 713 | 696 |
| Elmendorf Tear (g) | | | | | |
| MD | 974 | 1073 | 527 | 1071 | 637 |
| TD | 1464 | 1639 | 1678 | 1510 | 1403 |
| Haze (%) | 11.4 | 15.9 | 19.5 | N/A | N/A |
| Dart Drop | | | | | |
| (Phenolic Method A) | | | | | |
| (g) | 524 | 770 | 210 | 584 | 509 |
| (g/mil) | 147 | 214 | 114 | 168 | 143 |

TABLE 7
Properties of Films 1-8

| | FILMS | | | | | | | |
|---|---|---|---|---|---|---|---|---|
| Property | 1 | 2 | 3 | 4 | 5 | 6 | 7 | 8 |
| Thickness (mil) | | | | | | | | |
| Average | 3.63 | 3.54 | 3.55 | 3.62 | 3.53 | 3.54 | 3.47 | 3.52 |
| Low | 3.39 | 3.38 | 3.23 | 3.33 | 3.13 | 3.15 | 3.01 | 3.19 |
| High | 3.87 | 3.72 | 3.81 | 3.84 | 3.78 | 3.98 | 3.78 | 3.93 |
| 1% Secant (psi) | | | | | | | | |
| MD | 71,857 | 65,140 | 68,764 | 93,949 | 71,888 | 72,186 | 75,078 | 61,226 |
| TD | 71,787 | 65,102 | 67,706 | 90,423 | 73,250 | 68,094 | 71,135 | 56,094 |
| Tensile | | | | | | | | |
| Yield | | | | | | | | |
| Strength (psi) | | | | | | | | |
| MD | 2,327 | 2,270 | 2,259 | 2,978 | 2,370 | 2,379 | 2,400 | 2,093 |
| TD | 2,577 | 2,303 | 2,354 | 3,006 | 2,378 | 2,388 | 2,426 | 2,010 |
| Elongation at | | | | | | | | |
| Yield (%) | | | | | | | | |
| MD | 6.4 | 6.0 | 5.8 | 5.7 | 5.8 | 8.5 | 5.5 | 6.0 |
| TD | 6.4 | 6.3 | 6.2 | 6.4 | 5.5 | 7.5 | 6.2 | 5.6 |
| Tensile | | | | | | | | |
| Strength (psi) | | | | | | | | |
| MD | 7,299 | 6,920 | 7,351 | 8,640 | 6,571 | 8,349 | 8,349 | 8,373 |
| TD | 6,305 | 7,023 | 7,132 | 8,476 | 6,582 | 7,982 | 8,093 | 8,010 |
| Elongation at | | | | | | | | |
| Break (%) | | | | | | | | |
| MD | 620 | 628 | 624 | 656 | 636 | 657 | 639 | 638 |
| TD | 643 | 668 | 654 | 701 | 673 | 671 | 680 | 677 |
| Elmendorf | | | | | | | | |
| Tear (g) | | | | | | | | |
| MD | 561 | 826 | 1094 | 442 | 603 | 1000 | 888 | 1258 |
| TD | 1425 | 1549 | 1491 | 594 | 1365 | 1318 | 1387 | 1200 |
| Haze (%) | 12.8 | 11.1 | 11.7 | 26.0 | N/A | N/A | N/A | N/A |
| Dart Drop | | | | | | | | |
| (Phenolic | | | | | | | | |
| Method A) | | | | | | | | |
| (g) | 680 | 886 | 926 | 548 | 671 | >1382 | 1316 | >1382 |
| (g/mil) | 187 | 245 | 261 | 151 | 190 | >200 | 379 | >393 |

As used herein, “consisting essentially of” means that the claimed film, article or polymer composition includes only the named components and no additional components that will alter its measured properties by any more than 20, or 15, or 10%, and most preferably means that “additives” are present to a level of less than 5, or 4, or 3, or 2 wt % by weight of the composition. Such additional additives can include, for example, fillers, nucleators or clarifiers, colorants, antioxidants, alkyl-radical scavengers (preferably vitamin E, or other tocopherols and/or tocotrienols), anti-UV agents, acid scavengers, curatives and cross-linking agents, aliphatic and/or cyclic containing oligomers or polymers (often referred to as hydrocarbon resins), and other additives well known in the art. As it relates to a process, the phrase “consisting essentially of” means that there are no other process features that will alter the claimed properties of the polymer, polymer blend or article produced therefrom by any more than 10, 15 or 20%, but there may otherwise be minor process features not named.

For all jurisdictions in which the doctrine of “incorporation by reference” applies, all of the test methods, patent publications, patents and reference articles are hereby incorporated by reference either in their entirety or for the relevant portion for which they are referenced.

1. A film comprising at least a first layer comprising a polymer composition consisting essentially of:
a polypropylene comprising at least 50 mol % propylene and having an MFR within a range from 0.1 to 6 g/10 min, a molecular weight distribution (M_{w}/Mₙ) greater than 6, a branching index (g′vis) of at least 0.95, and a melt strength of at least 2 cN determined using an extensional rheometer at 190° C.; and
a polyethylene comprising at least 70 mol % ethylene and having: a density of from 0.910 g/cm³ to 0.923 g/cm³, a melt index (I₂) of from 0.1 g/10 min to 1.2 g/10 min, a melt index ratio (I₂₁/I₂) of from 20 to 35, and an orthogonal comonomer distribution.

2. The film of claim 1, wherein the polypropylene has a M_{w}/Mₙ from 6 to 18.

3. The film of claim 1, wherein the polypropylene has a melt strength from 2 cN to 80 cN.

4. The film of claim 1, wherein the polypropylene has a peak extensional viscosity (annealed) within a range from 15 kPa·s to 100 kPa·s at a strain rate of 0.01 sec¹ (190° C.).

5. The film of claim 1, wherein the polypropylene comprises at least 90 mol % propylene.

6. The film of claim 1, wherein the polyethylene has a melt strength of from 1 to 25 cN.

7. The film of claim 1, wherein the polypropylene is present in an amount of 30 wt % to 70 wt %, based on the total weight of the composition, and the polyethylene is present in an amount of 30 wt % to 70 wt %, based on the total weight of the composition.

8. The film of claim 1, wherein the polypropylene is present in an amount of 30 wt % to 50 wt %, based on the total weight of the composition, and the polyethylene is present in an amount of 50 wt % to 70 wt %, based on the total weight of the composition.

9. The film of claim 1, having a 1% secant flexural modulus (MD or TD) of at least 55,000 psi and a dart drop of at least 500 g.

10. The film of claim 9, wherein the film has a 1% secant flexural modulus (MD or TD) of at least 65,000 psi and a dart drop of at least 600 g.

11. The film of claim 9, wherein the polymer film has an Elmendorf Tear (MD or TD) within a range from 400 g to 1600 g.

12. The film of claim 9, wherein the polymer film has a haze of less than 30%.

13. The film of claim 9, having an average thickness within a range from greater 80 μm to 1.2 mm.

14. The film of claim 9, further comprising at least a second and a third layer comprising one or more of the polypropylene, the polyethylene and a different polyethylene.

15. The film of claim 14, wherein the first layer is present in an amount of 40 wt % to 70 wt % and the second layer and the third layer are each present in an amount of 15 wt % to 30 wt %.

16. The film of claim 14 having a second layer/first layer/third layer structure.
